(19) United States
(12) Patent Application Publication
(10) Pub. No.: US 2020/0282790 A1
(43) Pub. Date: Sep. 10, 2020

(54) HIGH-TORSION AIR STRUT

(71) Applicant: Continental Automotive Systems, Inc., Auburn Hills, MI (US)

(72) Inventors: Joseph G Jerisk, Burton, MI (US); Garrett Mark Pniewski, Bloomfield Hills, MI (US)

(73) Assignee: Continental Automotive Systems, Inc., Auburn Hills, MI (US)

(21) Appl. No.: 16/291,859

(22) Filed: Mar. 4, 2019

(51) Int. Cl. B60G 15/12; F16F 9/36; F16F 9/02; F16F 9/32

(52) U.S. Cl. CPC B60G 15/12; F16F 9/3228; F16F 9/0227; F16F 9/368

(57) ABSTRACT

An air spring assembly for a vehicle having a damper body which is decoupled from the bellow of a piston, allowing the damper to rotate freely without inducing torsion into the piston. The design includes a two-piece piston having both an inner piston and an outer piston which are connected together, and a portion of the inner piston is positioned over the damper tube. The piston having the two-piece design allows for the two-piece piston to fully decouple from the damper without leakage. The inner piston retains a rotary O-ring which seals to a damper rod to keep air within the air spring assembly. The air spring assembly also includes a thrust bearing located between the inner piston and the top surface of the damper tube. The thrust bearing allows full decoupling from the inner piston and the damper, ensuring that there is no torsion translated to the bellow.

### FIELD OF THE INVENTION

The invention relates generally to an air spring assembly which is more tolerant of torsion induced by vehicle kinematics.

### BACKGROUND OF THE INVENTION

Suspension systems for automotive vehicles provide vehicle passengers with a more comfortable ride. Air suspension systems utilize air springs, rather than traditional coil springs. Air suspension systems provide different suspension qualities that may be preferable in some vehicles to traditional coil spring suspensions.

A conventional aft spring is a device that is arranged between a vehicle body and chassis. The typical air spring has at least one working space, or cavity that is filled with compressed air. Air spring pistons typically seal the aft chamber against a hydraulic shock absorber (damper). Vehicle kinematics may induce torsion into the air spring assembly during the operation of the vehicle. Many air spring systems are limited by the amount of torsion they are able to withstand, and are not equipped to handle torsion levels above a certain threshold.

Some air springs fail when exposed to a high-torsion event (i.e., greater than ±1.25°), one type of failure is a rupture in the bellow, resulting in leakage in the air spring.

Accordingly, there exists a need for an air spring assembly which is able to tolerate increased levels of torsion induced by vehicle kinematics.

### SUMMARY OF THE INVENTION

The present invention is an air spring assembly for a vehicle which allows a damper body to decouple from the air spring, allowing the damper to rotate freely without inducing torsion into the bellow.

The design of the air spring assembly of the present invention functions to decouple the piston from the damper. The design includes a two-piece piston having both an inner piston and an outer piston which are connected together, and a portion of the inner piston is positioned over the damper tube. The piston having the two-piece design of the present invention allows for the two-piece piston to fully decouple from the damper without leakage. The inner piston retains a rotary O-ring which seals to a damper rod to keep air within the air spring assembly. The air spring assembly of the present invention also includes a thrust bearing which is located between the inner piston and the top surface of the damper tube, where the thrust bearing allows full decoupling from the inner piston and the damper. The configuration of the two-piece piston and the thrust bearing ensure that there is no torsion translated to the bellow.

In one embodiment, the present invention is an air spring assembly which includes a damper body, and a damper rod partially extending into the damper body, where the damper rod is able to move relative to the damper body. The air spring assembly also includes an inner piston, an outer piston connected to the inner piston, and a portion of the damper body is surrounded by the inner piston. The air spring assembly also includes a bearing pressed between the damper body and the inner piston, and the bearing allows for rotation of the damper body relative to the piston assembly and the damper rod, preventing torsion from being transferred from the damper body to the piston assembly and into the bellow.

In one embodiment, the bearing includes an inner race wall portion connected to the inner piston, and an outer race wall portion located on and connected to the top surface of the damper body. At least one bearing member is disposed between the inner race wall portion and the outer race wall portion, and the at least one bearing member allows the outer race wall portion and the damper body to move relative to the inner race wall portion, the inner piston, and outer piston.

In one embodiment, the inner piston includes a main body portion, a groove integrally formed with the main body portion, and a seal disposed in the groove. The seal is in contact with the damper rod such that the seal prevents air from leaking out of the air spring assembly as the damper rod moves relative to the damper body. The inner piston also includes a cylindrical flange portion integrally formed with the main body portion, and a portion of the cylindrical flange portion circumscribes the bearing and the damper body.

In one embodiment, the outer piston includes a plurality of flange portions, and each of the plurality of flange portions is connected to the cylindrical flange portion of the inner piston.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a sectional view of an air spring assembly, according to embodiments of the present invention;

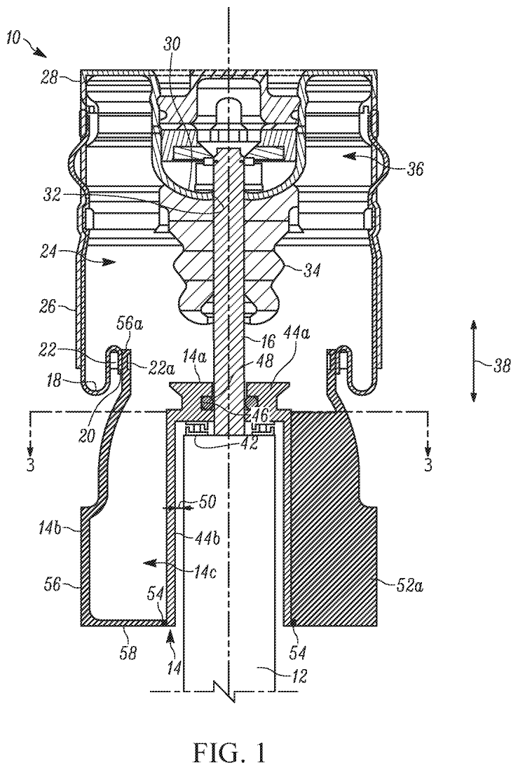

FIG. 2 an enlarged view of a portion of a sectional view of an air spring assembly, according to embodiments of the present invention;

FIG. 3 is a sectional view taken along lines 3-3 of FIG. 2.

### DETAILED DESCRIPTION OF THE PREFERRED EMBODIMENTS

The following description of the preferred embodiment(s) is merely exemplary in nature and is in no way intended to limit the invention, its application, or uses.

An air spring assembly having a decoupling mechanism according to the present invention is shown in the Figures, generally at 10. Referring to the Figures generally, the air spring 10 includes a damper body 12, and surrounding a portion of the damper body 12 is a piston, shown generally at 14. The piston 14 may be manufactured as a single unitary component or multiple components. In the embodiment shown in the Figures, the piston 14 is a piston assembly 14 which includes an inner piston 14a connected to an outer piston 14b, where both the inner piston 14a and the outer piston 14b are made from an injection molded material, such as an injection molded plastic material, but it is within the scope of the invention that the inner piston 14a and the outer piston 14b may be made of other materials, such as, but not limited to, metal, such as steel, or aluminum. The inner piston 14a and the outer piston 14b may also be made using different manufacturing processes other than injection molding, such as metal injection molding, casting, sintering, or stamping.

Extending into the damper body 12 is a damper rod 16, such that the damper body 12 is able to move relative to the damper rod 16. The air spring 10 also includes a bellow 18, which is flexible and able to change shape as the piston assembly 14 is moved relative to the damper rod 16. A free end 20 of the bellow 18 is clamped between a clamping ring 22 and a portion of the outer piston 14b. A portion of the outer piston 14b is overmolded around a support ring 22a, which is used to provide support against the force of the clamping ring 22 on the bellow 18 and the portion of the outer piston 14b to which force is applied by the clamping ring 22.

The bellow 18 includes a cavity, shown generally at 24, which is generally filled with air. The bellow 18 is partially surrounded by a guide tube 26, and the guide tube 26 and the bellow 18 are connected to a top cap 28. The top cap 28 includes a base portion 30, and extending through an aperture 32 in the base portion 30 is the damper rod 16. The damper rod 16 also extends through a jounce bumper 34, which is partially surrounded by, and connected, to the top cap 28.

The top cap 28 also has a cavity, shown generally at 36, which is in fluid communication with the cavity 24 of the bellow 18. The piston assembly 14 also includes a cavity, shown generally at 14c, which is formed by the assembly of the inner piston 14a and the outer piston 14b. The cavities 24,36,14c define a volume which changes as the piston assembly 14 and damper 12 move relative to the damper rod 16.

The top cap 28 is connected to another component of the vehicle, such as the frame of the vehicle, but it is within the scope of the invention that the top cap 28 may be connected to other components of the vehicle as well. Additionally, the damper body 12 is connected to another part of the suspension system of the vehicle, such as an A-arm, or swing arm. As the A-arm moves from (operation of the vehicle) the damper body 12 and piston 14 move in either of the directions indicated by arrow 38 relative to the damper rod 16.

As the vehicle is in operation, and travelling, there may be instances where the vehicle kinematics induce torsion into the air spring assembly 10.

The air spring assembly 10 includes a decoupling mechanism, where the piston assembly 14 is part of the decoupling mechanism. The decoupling mechanism reduces or eliminates the transfer of torsion from the damper body 12 to the piston assembly 14. The decoupling mechanism includes a bearing, shown generally at 42, which in this embodiment is a thrust bearing 42. The thrust bearing 42 includes an inner race wall portion 42a, an outer race wall portion 42b, and a plurality of bearing members 42c disposed between the inner race wall portion 42a and outer race wall portion 42b. The inner race wall portion 42a is in contact with a bottom surface of the inner piston 14a, and the outer race wall portion 42b is in contact with the top surface 12a of the damper body 12.

The inner piston 14a includes main body portion 44a, and a cylindrical flange portion 44b integrally formed with the main body portion 44a, where the cylindrical flange portion 44b extends downwardly along the outer surface of the damper body 12 such that the cylindrical flange portion 44b partially circumscribes the damper body 12. The inner piston 14a also includes a groove 46 formed as part of the main body portion 44a, and disposed in the groove 46 is a seal 48, which in this embodiment is an O-ring. The O-ring 48 is made of any suitable material which is capable of withstanding rotation and abrasion and maintain a seal. The O-ring 48 is in contact with the damper rod 16, and prevents air from escaping the cavities 24,36,14c, even as the damper rod 16 moves relative to the O-ring 48. The inner piston 14a is also positioned such that there is a clearance 50 between the cylindrical flange portion 44 and the damper body 12, such that the damper body 12 and the cylindrical flange portion 44 do not contact each other.

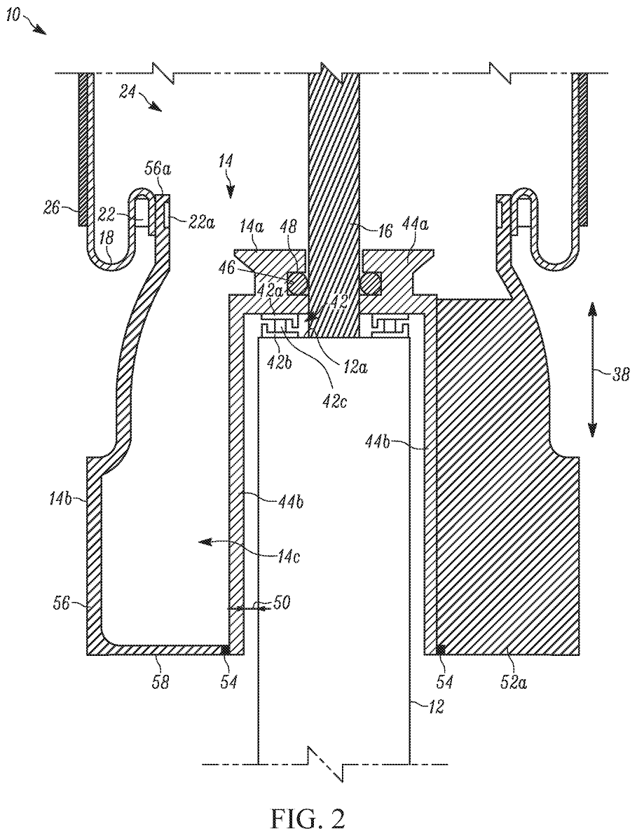

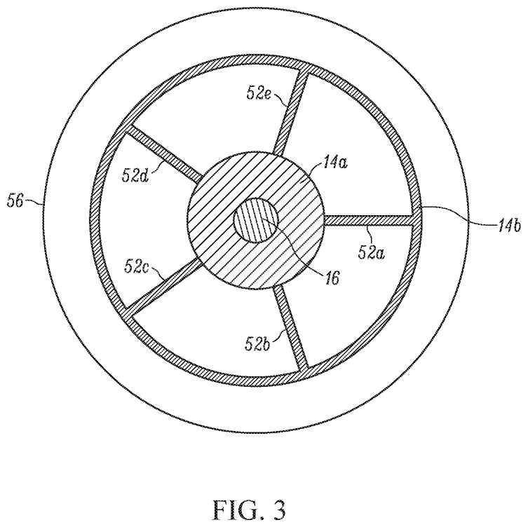

Referring to FIGS. 2-3, the outer piston 14b includes a plurality of flange portions 52a,52b,52c,52d,52e which are connected to the cylindrical flange portion 44 through an attachment feature 54. In one embodiment, the attachment feature 54 is a hot gas weld, but it is within the scope of the invention that other types of attachment features may be used, such as, but not limited to, an ultrasonic weld or a laser weld. The attachment feature 54 is only connected to part of each flange portion 52a,52b,52c,52d,52e, and the remainder of each flange portion 52a,52b,52c,52d,52e is in contact with the outer surface of the cylindrical flange portion 44b of the outer piston 14b. The attachment feature 54 circumscribes the cylindrical flange portion 44b, such that the attachment feature 54 also connects a bottom flange portion 58 to the cylindrical flange portion 44b. Each of the plurality of flange portions 52a,52b,52c,52d,52e are integrally formed with an outer shell portion 56 of the outer piston 14b. The outer shell portion 56 also includes a contour shell portion 56a, which the contour shell 56a defines a portion of the shape of the bellow 18 as the bellow 18 moves during operation of the air spring assembly 10.

The air spring assembly 10 also includes a flexible outer cover, which in this embodiment is a gaiter (not shown). The gaiter is connected to the guide tube 26, and to a connector which is part of the damper body 12. The gaiter flexes and moves as the damper body 12 and moves during travel of the vehicle.

During vehicle travel, there are instances where torsion is induced to the air spring assembly 10. This torsion is typically induced to the air spring assembly 10 as the damper body 12 is subjected to different torsions from other components in the suspension system. The damper body 12 and the outer race wall portion 42b of the bearing 42 rotate relative to the piston assembly 14 and the inner race wall portion 42a of the bearing 42.

Because the damper body 12 moves relative to the damper rod 16, the piston assembly 14 also moves relative to the damper rod 16 in the same manner. The seal 48 is therefore in frictional contact with the damper rod 12, where the seal 48 prevents air from exiting the cavities 24,36,14c. The bearing 42 facilitates the rotation of the piston assembly 14 relative to the damper body 12, and because the damper body 12 is able to rotate relative to the piston assembly 14, this relative movement reduces or eliminates the torsion that is induced to the piston assembly 14 from the damper body 12 by other suspension system components.

While the bearing 42 has been described, it is within the scope of the invention that other types of components may be used, such as, but not limited to, a ball bearing, a needle bearing, a journal bearing, a bushing, or the like.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A apparatus comprising:
an air spring assembly, including:
a damper body;
a damper rod partially extending into the damper body, the damper rod able to move relative to the damper body;
a piston, a portion of the damper body surrounded by the piston; and
a decoupling mechanism connected to the damper body and the piston;
wherein the decoupling mechanism allows for rotation of the damper body relative to the piston and the damper rod, preventing torsion from being transferred from the damper body to the piston and the damper rod.

2. The apparatus of claim 1, the decoupling mechanism further comprising a bearing.

3. The apparatus of claim 2, the bearing further comprising:
an inner race wall portion connected to the piston;
an outer race wall portion connected to the damper body; and
at least one bearing member disposed between the inner race portion and the outer race wall portion;
wherein the at least one bearing member allows inner race wall portion and the piston to move relative to the outer race wall portion and the damper body.

4. The apparatus of claim 2, wherein the outer race wall portion is located on a top surface of the damper body.

5. The apparatus of claim 1, the piston further comprising:
a groove; and
a seal disposed in the groove, the seal being in contact with the damper rod;
wherein the seal prevents air from leaking out of the air spring assembly as the damper rod moves relative to the damper body.

6. The apparatus of claim 1, the piston further comprising:
a cylindrical flange portion;
wherein a portion of the cylindrical flange portion circumscribes the decoupling mechanism and part of the damper body.

7. The apparatus of claim 1, the piston further comprising
a plurality of flange portions;
wherein each of the plurality of flange portions is connected to the inner piston.

8. The apparatus of claim 1, the piston further comprising a two-piece piston assembly.

9. An air spring assembly for a vehicle, including:
a damper body;
a damper rod partially extending into the damper body, the damper rod able to move relative to the damper body;
an inner piston, a portion of the damper body surrounded by the inner piston;
an outer piston connected to the inner piston; and
a bearing pressed between to the damper body and the inner piston;
wherein the bearing allows for rotation of the damper body relative to the piston assembly and the damper rod, preventing torsion from being transferred from the damper body to the piston assembly and into the bellow.

10. The air spring assembly of claim 9, the bearing further comprising:
an inner race wall portion connected to the inner piston;
an outer race wall portion connected to the damper body; and
at least one bearing member disposed between the inner race wall portion and the outer race wall portion;
wherein the at least one bearing member allows the outer race wall portion and the damper body to move relative to the inner race wall portion, the inner piston, and outer piston.

11. The air spring assembly of claim 10, wherein the outer race wall portion is located on a top surface of the damper body

12. The air spring assembly of claim 9, the inner piston further comprising:
a main body portion;
a groove integrally formed with the main body portion;
a seal disposed in the groove, the seal being in contact with the damper rod such that the seal prevents air from leaking out of the air spring assembly as the damper rod moves relative to the damper body; and
a cylindrical flange portion integrally formed with the main body portion;
wherein a portion of the cylindrical flange portion circumscribes the bearing and the damper body.

13. The air spring assembly of claim 12, the outer piston further comprising:
a plurality of flange portions;
wherein each of the plurality of flange portions is connected to the cylindrical flange portion.
